(19) United States
(12) Patent Application Publication
(10) Pub. No.: US 2026/0136365 A1
(43) Pub. Date: May 14, 2026

(54) WIRELESS COMMUNICATION METHOD, TERMINAL DEVICE, AND NETWORK DEVICE

(71) Applicant: QUECTEL WIRELESS SOLUTIONS CO., LTD., Shanghai (CN)

(72) Inventor: Zheng ZHAO, Shanghai (CN)

(21) Appl. No.: 19/442,984

(22) Filed: Jan. 7, 2026

Related U.S. Application Data
(63) Continuation of application No. PCT/CN2024/098009, filed on Jun. 7, 2024.

(51) Int. Cl. H04W 72/20; H04W 48/08

(52) U.S. Cl. CPC H04W 72/20; H04W 48/08

(57) ABSTRACT

Disclosed are a wireless communication method, a terminal device, and a network device. One example method includes: receiving, by a terminal device from a network device, first information that is associated with a target synchronization signal block (SSB), wherein the first information indicates that the target SSB is not used by the terminal device to access a first cell associated with the target SSB, wherein the target SSB is a non-cell defining SSB or a cell defining SSB; and transmitting, by the terminal device, a request for the target SSB.

### CROSS-REFERENCE TO RELATED APPLICATIONS

This application is a continuation of International Application No. PCT/CN2024/098009, filed on Jun. 7, 2024, the disclosure of which is hereby incorporated by reference in its entirety.

### TECHNICAL FIELD

The present application relates to the field of communications technologies, and more specifically, to a wireless communication method, a terminal device, and a network device.

### BACKGROUND

In a communications system, the terminal device may perform initial access based on a target synchronization signal block (synchronization signal block/physical broadcast channel block, SS/PBCH block, SSB) (for example, a cell defining SSB). However, when the target SSB is an on-demand SSB, the terminal device that does not support the on-demand SSB performs initial access based on the target SSB, which may cause an access error.

### SUMMARY

Provided in the present application are a wireless communication method, a terminal device, and a network device. Various aspects involved in the present application are described below.

According to a first aspect, a wireless communication method is provided, including: receiving, by a terminal device, first information that is associated with a target SSB and that is transmitted by a network device, where the first information is used to indicate that the target SSB is not used by the terminal device to access a first cell associated with the target SSB, where the target SSB is a non-cell defining SSB or a cell defining SSB, and transmission of the target SSB is triggered based on a request of the terminal device.

According to a second aspect, a wireless communication method is provided, including: in response to a first event, receiving, by a terminal device, fourth information transmitted by a network device, where the fourth information is used to instruct to activate a target SSB in a secondary cell, and transmission of the target SSB is triggered based on a request of the terminal device, where the first event includes one or more of the following: that the secondary cell is configured; that the secondary cell is activated; or that the network device instructs to activate the secondary cell.

According to a third aspect, a wireless communication method is provided, including: transmitting, by a network device, first information associated with a target SSB to a terminal device, where the first information is used to indicate that the target SSB is not used by the terminal device to access a first cell associated with the target SSB, where the target SSB is a non-cell defining SSB or a cell defining SSB, and transmission of the target SSB is triggered based on a request of the terminal device.

According to a fourth aspect, a wireless communication method is provided, including: in response to a first event, transmitting, by a network device, fourth information to a terminal device, where the fourth information is used to instruct to activate a target SSB in a secondary cell, and transmission of the target SSB is triggered based on a request of the terminal device, where the first event includes one or more of the following: that the secondary cell is configured; that the secondary cell is activated; or that the network device instructs to activate the secondary cell.

According to a fifth aspect, a terminal device is provided, including: a receiving unit, receiving first information that is associated with a target SSB and that is transmitted by a network device, where the first information is used to indicate that the target SSB is not used by the terminal device to access a first cell associated with the target SSB, where the target SSB is a non-cell defining SSB or a cell defining SSB, and transmission of the target SSB is triggered based on a request of the terminal device.

According to a sixth aspect, a terminal device is provided, including: a receiving unit, in response to a first event, receiving fourth information transmitted by a network device, where the fourth information is used to instruct to activate a target SSB in a secondary cell, and transmission of the target SSB is triggered based on a request of the terminal device, where the first event includes one or more of the following: that the secondary cell is configured; that the secondary cell is activated; or that the network device instructs to activate the secondary cell.

According to a seventh aspect, a network device is provided, including: a transmitting unit, transmitting first information associated with a target SSB to a terminal device, where the first information is used to indicate that the target SSB is not used by the terminal device to access a first cell associated with the target SSB, where the target SSB is a non-cell defining SSB or a cell defining SSB, and transmission of the target SSB is triggered based on a request of the terminal device.

According to an eighth aspect, a network device is provided, including: a transmitting unit, in response to a first event, transmitting fourth information to a terminal device, where the fourth information is used to instruct to activate a target SSB in a secondary cell, and transmission of the target SSB is triggered based on a request of the terminal device, where the first event includes one or more of the following: that the secondary cell is configured; that the secondary cell is activated; or that the network device instructs to activate the secondary cell.

According to a ninth aspect, a terminal device is provided, including a processor, a memory, and a communications interface. The memory is configured to store one or more computer programs. The processor is configured to invoke the computer program in the memory, to cause the terminal device to execute some or all of the steps in the method according to the first aspect and/or the second aspect.

According to a tenth aspect, a network device is provided, including a processor, a memory, and a transceiver. The memory is configured to store one or more computer programs. The processor is configured to invoke the computer program in the memory, to cause the network device to execute some or all of the steps in the method according to the third aspect and/or the fourth aspect.

According to an eleventh aspect, an embodiment of the present application provides a communications system, and the system includes the terminal device and/or the network device described above. In another possible design, the system may further include another device that interacts with the terminal device or the network device in the solutions provided in embodiments of the present application.

According to a twelfth aspect, an embodiment of the present application provides a computer-readable storage medium. The computer-readable storage medium stores a computer program. The computer program causes a communications device (for example, a terminal device or a network device) to execute some or all of the steps in the method according to the foregoing aspects.

According to a thirteenth aspect, an embodiment of the present application provides a computer program product. The computer program product includes a non-transitory computer-readable storage medium that stores a computer program; and the computer program is operable to cause a communications device (for example, a terminal device or a network device) to execute some or all of the steps in the method according to the foregoing aspects. In some implementations, the computer program product may be a software installation package.

According to a fourteenth aspect, an embodiment of the present application provides a chip. The chip includes a memory and a processor. The processor may invoke and run a computer program in the memory, to implement some or all of the steps of the method according to the foregoing aspects.

In embodiments of the present application, the network device transmits the first information to the terminal device, to indicate that the target SSB transmitted on demand is not used by the terminal device to access the first cell associated with the target SSB. An access error of the terminal device that does not support an on-demand SSB may be reduced based on the first information, to improve communication efficiency.

### BRIEF DESCRIPTION OF DRAWINGS

FIG. 1 shows a wireless communications system 100 to which an embodiment of the present application is applied.

FIG. 2 is a schematic flowchart of a wireless communication method according to an embodiment of the present application.

FIG. 3 is a schematic flowchart of a wireless communication method according to another embodiment of the present application.

FIG. 4 is a schematic diagram of a first event according to an embodiment of the present application.

FIG. 5 is a schematic diagram of a terminal device according to an embodiment of the present application.

FIG. 6 is a schematic diagram of a terminal device according to another embodiment of the present application.

FIG. 7 is a schematic diagram of a network device according to an embodiment of the present application.

FIG. 8 is a schematic diagram of a network device according to another embodiment of the present application.

FIG. 9 is a schematic diagram of a structure of a communications apparatus according to an embodiment of the present application.

### DESCRIPTION OF EMBODIMENTS

The technical solutions in the present application are described below with reference to the accompanying drawings.

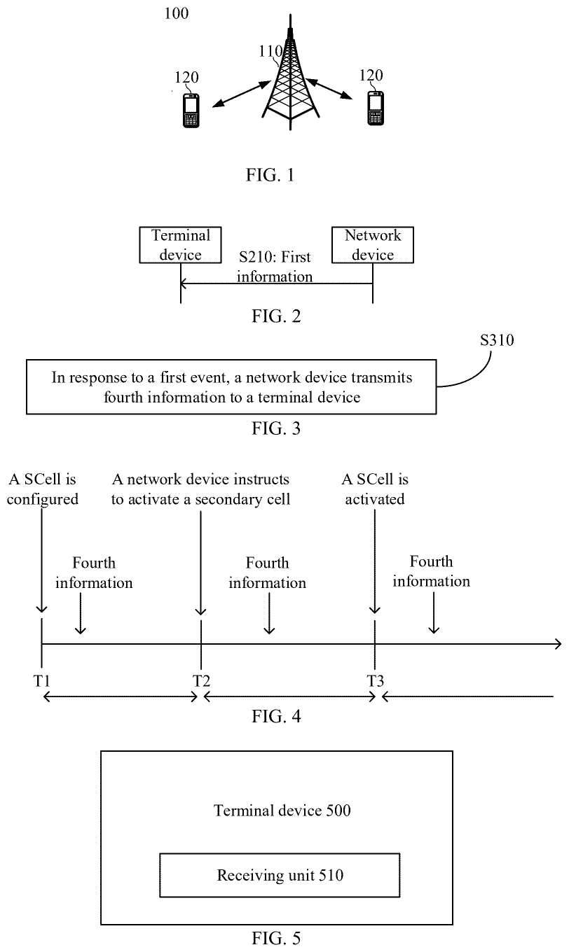

FIG. 1 shows a wireless communications system 100 to which an embodiment of the present application is applied. The wireless communications system 100 may include a network device 110 and terminal devices 120. The network device 110 may be a device that communicates with the terminal device 120. The network device 110 may provide communication coverage for a specific geographic region, and may communicate with the terminal device 120 located within the coverage.

FIG. 1 schematically shows one network device and two terminals. Optionally, the wireless communications system 100 may include a plurality of network devices, and another quantity of terminal devices may be included within coverage of each network device. This is not limited in embodiments of the present application.

Optionally, the wireless communications system 100 may further include other network entities such as a network controller and a mobility management entity. This is not limited in embodiments of the present application.

It should be understood that the technical solutions of embodiments of the present application may be applied to various communications systems, such as a 5th generation (5th generation, 5G) system or a new radio (new radio, NR) system, a long term evolution (long term evolution, LTE) system, an LTE frequency division duplex (frequency division duplex, FDD) system, and an LTE time division duplex (time division duplex, TDD) system. The technical solutions provided in the present application may further be applied to a future communications system, such as a 6th generation mobile communications system or a satellite communications system.

The terminal device in embodiments of the present application may also be referred to as a user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, or a user apparatus. The terminal device in embodiments of the present application may be a device providing a user with voice and/or data connectivity and capable of connecting people, objects, and machines, such as a handheld device or a vehicle-mounted device having a wireless connection function. The terminal device in embodiments of the present application may be a mobile phone (mobile phone), a tablet computer (Pad), a notebook computer, a palmtop computer, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, the UE may be configured to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relay of a communication signal through a base station.

A network device in embodiments of the present application may be a device for communicating with the terminal device. The network device may also be referred to as an access network device or a radio access network device. For example, the network device may be a base station. The network device in embodiments of the present application may be a radio access network (radio access network, RAN) node (or device) that connects the terminal device to a wireless network. The base station may broadly cover the following various names, or may be interchanged with the following names, such as a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNode MeNB, a secondary eNode SeNB, a multi-standard radio (MSR) node, a home base station, a network controller, an access node, a radio node, an access point (access point, AP), a transmission node, a transceiver node, a baseband unit (baseband unit, BBU), a remote radio unit (Remote Radio Unit, RRU), an active antenna unit (active antenna unit, AAU), a remote radio head (remote radio head, RRH), a central unit (central unit, CU), a distributed unit (distributed unit, DU), and a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (vehicle-to-everything, V2X), and machine-to-machine (machine-to-machine, M2M) communication, a network-side device in a 6G network, a device that functions as a base station in a future communications system, or the like. The base station may support networks of a same access technology or different access technologies. A specific technology and a specific device used by the network device are not limited in embodiments of the present application.

The base station may be fixed or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device in communication with another base station.

In some deployments, the network device in embodiments of the present application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

It should be understood that all or some of functions of the communications device in the present application may also be implemented by software functions running on hardware, or by virtualization functions instantiated on a platform (for example, a cloud platform).

### Secondary Cell (Secondary Cell, SCell)

Carrier aggregation (carrier aggregation, CA) means that two or more carriers (component carriers, CC) are aggregated into a wider bandwidth resource to transmit data. In a carrier aggregation scenario, in addition to a primary cell (primary cell, PCell), one or more SCells are further configured in a system. These cells jointly provide users with higher data rates and better coverage. Therefore, the system can support more users and a higher throughput, and can effectively use scattered spectrum resources to improve utilization of the spectrum resources. In some scenarios, coverage performance of a network can be improved by aggregating carriers on different frequency bands.

Before carrying communication data, the SCell needs to be configured and activated. The configuration of the SCell is mainly completed by using radio resource control (radio resource control, RRC) signalling, including an RRC connection reconfiguration (RRCConnectionReconfiguration), to add, modify, or release the SCell, and activate or deactivate the SCell by using a medium access control control element (medium access control control element, MAC CE). The system allocates a unique cell identity (cell identity) to the SCell. After being activated, the SCell starts to undertake a part of user data transmission, and a network device dynamically allocates resources based on a network load and user requirements for scheduling and management. The SCell registers with a core network (for example, an evolved packet core (evolved packet core, EPC)) to obtain a necessary network resource and a necessary license. The network device (for example, a base station) and a network management system continuously monitor performance of the SCell, and perform optimization and adjustment based on a measurement report and feedback of the network device, to ensure the best performance of the SCell.

A terminal device (for example, a UE) is first connected to the primary cell (PCell) to establish an initial RRC connection. The network device (for example, a NodeB) configures the terminal device to perform signal measurement of a neighboring cell (including the SCell). A specific measurement configuration is delivered by using RRC signalling, and includes a measurement object, an event type (such as A1, A2, A3, A4, and A5), a measurement quantity (such as reference signal received power (reference signal received power, RSRP) and reference signal received quality (reference signal received quality, RSRQ)), and the like.

The terminal device performs signal measurement of the neighboring cell based on the configuration, and reports a measurement report to the network device (for example, a base station) when a trigger condition is satisfied. The measurement report includes signal strength and quality information of the neighboring cell (including the SCell).

The network device determines, based on the measurement report, whether to add the SCell. If the network device determines to add the SCell, the network device delivers, to the terminal device by using an RRC connection reconfiguration message, an indication for adding the SCell. The RRC connection reconfiguration message includes configuration parameters of the SCell, for example, a physical cell ID, a frequency band, transmit power, and synchronization information. These parameters are used to indicate how to connect and use the SCell for the terminal device.

After the SCell is added, the network device further delivers an activation indication. The activation indication includes an activation time and related scheduling information. After receiving the activation indication, the terminal device activates the SCell based on the configuration, and acknowledges this case to the network device by using an RRC connection reconfiguration complete message (RRCConnectionReconfigurationComplete).

In a communications system (for example, NR), the configuration and the activation of the SCell involve a plurality of steps, from discovery and measurement to configuration and activation, and from configuration instructions of the network device to specific operations of the terminal device.

Before configuring the SCell, the terminal device first needs to discover and measure the neighboring cell. The terminal device receives the measurement object (measurement object, MO), and the network device transmits the MO to the terminal device by using RRC signalling, to specify a frequency band and a cell that need to be measured. SSB measurement timing configuration (SSB measurement timing configuration, SMTC) information included in the MO instructs the terminal device to measure an SSB of the neighboring cell in a specific time window. The following is an example of a measurement configuration message.

```
MeasurementConfig:
  - MeasurementObject:
    - Earfcn: <frequency>
    - MeasurementQuantity: RSRP
  - ReportConfig:
    - EventId: A3
    - Threshold: −110 dBm
    - Hysteresis: 2 dB
    - TimeToTrigger: 320 ms
```

The terminal device measures the SSB of the neighboring cell based on the MO and the SMTC, and collects information such as signal strength (such as RSRP) and quality (such as RSRQ and a signal-to-interference-plus-noise ratio (signal interference noise ratio, SINR)). The terminal device reports measurement results to the network device, so that the network device makes a configuration decision based on these results. For a measurement report message, reference is made to the following:

```
UE −> eNodeB: MeasurementReport
Report:
  - EventId: A3
  - MeasuredObjectId: 1
  - MeasurementResult: −105 dBm
```

The network device transmits the RRC connection reconfiguration message to the terminal device, where the RRC connection reconfiguration message includes configuration information of the SCell, for example, a frequency band and a bandwidth of the SCell, a physical cell identifier (physical cell identifier, PCI) of the SCell, and downlink and uplink configurations of the SCell. The following is an example of the RRC connection reconfiguration message.

```
eNodeB −> UE: RRCConnectionReconfiguration
ScellToAddModList:
  - ScellIndex: 1
  - ServingCellId: 2
  - DownlinkFrequency: <frequency>
  - UplinkFrequency: <frequency>
  - CellIndividualOffset: 0 dB
```

After receiving the RRC connection reconfiguration message, the terminal device transmits acknowledgment information to the network device (for example, a base station), and configures related parameters of the SCell based on information in the message.
UE→eNodeB: RRC ConnectionReconfigurationComplete

After the configuration of the SCell is completed, the network device may dynamically activate or deactivate the SCell as required, to optimize resource utilization and user experience. Activation and deactivation processes are implemented by using a MAC CE. The MAC CE is special control signalling used to transfer control information of a MAC layer. A processing delay of the MAC CE is less than that of control information signalling of an RRC layer, so that the SCell can be activated quickly. The following is an example of activation by using RRC signalling.

```
eNodeB −> UE: RRCConnectionReconfiguration
ScellToActivateList:
  - ScellIndex: 1
  - ActivationTime: <time>
```

After receiving an activation command, the terminal device starts to perform data transmission on the SCell. This includes starting physical layer processing and resource scheduling of the SCell.

The SCell is successfully configured and activated by using the foregoing steps, and the terminal device can perform data transmission by using the SCell, thereby improving a network capacity and user experience. This process relies on precise configuration and management of RRC signalling to ensure effective addition and activation of the SCell. When the network device determines that the SCell is no longer needed, the network device transmits a deactivation command to the terminal device by using a MAC CE. After receiving the deactivation command, the terminal device stops data transmission on the SCell, and releases a related resource.

In a wireless communications system, in a scenario of carrier aggregation and multi-cell deployment, an SSB of the SCell can help the terminal device perform functions such as synchronization, connection, inter-cell handover, and measurement. The SSB includes a synchronization signal (synchronization signals, SS) and a physical broadcast channel (physical broadcast channel, PBCH). The SSB is used for initial access, synchronization, and obtaining cell broadcast information of the terminal device.

In the wireless communications system, the SCell usually does not transmit the SSB. The SSB is mainly used for the PCell, and the SCell usually does not need to transmit the SSB. Carrier aggregation allows a plurality of carriers to be used for data transmission at the same time. The PCell is responsible for controlling signals and most management functions, and the SCell is mainly used to enhance a data throughput. Therefore, the SCell does not need to transmit the SSB because synchronization and broadcast information has been transmitted by the PCell. In addition, initial access and synchronization functions are usually performed by the PCell. The SCell is mainly used to increase the bandwidth and the capacity of data transmission. Therefore, the SCell does not need to transmit the SSB to provide synchronization information. The terminal device has obtained the necessary synchronization information by using the PCell. In addition, the SCell is usually used in dense regions or hotspot regions to provide an additional bandwidth. Terminal devices in these regions have been synchronized and accessed a network through the PCell. The SCell needs to be responsible only for extra data transmission. Because transmission of the SSB consumes additional power and resources, non-transmission of the SSB in the SCell facilitates saving energy and reducing interference. When the SSB does not need to be transmitted, the SCell may be activated and used as required, thereby improving overall network efficiency. The SCell may be on a higher frequency band. These frequency bands are mainly used for high-throughput data transmission rather than signal coverage and synchronization. Therefore, SSB transmission is not a necessity on these frequency bands.

The SCell does not transmit the SSB mainly because of its secondary role in the wireless communications system, and is mainly responsible for data transmission rather than synchronization and control functions, because the terminal device has performed synchronization and initial access by using the PCell. When the terminal device completes synchronization and initial access by using an SSB of the PCell, the SCell only needs to be configured and activated by using RRC signalling. In a case of limited spectrum resources, reducing unnecessary SSB transmission may improve spectrum efficiency and reduce power consumption of the network device and the terminal device, especially power consumption on a network device side.

However, in some specific scenarios, the SCell may need to transmit the SSB. For example, in some standalone deployment (Standalone Deployment) scenarios, the SCell may need to transmit the SSB to support synchronization and access of the terminal device. In some complex handover scenarios, SSB transmission in the SCell can help the terminal device more successfully complete handover between cells. To reduce the power consumption of the network device and the terminal device, in some implementations, the on-demand SSB may be configured in the SCell, that is, the SSB may be configured in the SCell, where SSB transmission is triggered based on a request of the terminal device.

When the SCell is configured, and the terminal device has not received activation of the SCell, the SCell is a serving cell of the terminal device. The SSB in the SCell may be configured for the terminal device by using ServingCellConfigCommon. Content of ServingCellConfigCommon is as follows:

| ServingCellConfigCommon ::= | SEQUENCE { | |
|---|---|---|
| physCellId | PhysCellId | OPTIONAL, -- |

Cond HOAndServCellAdd,

| | | |
|---|---|---|
| downlinkConfigCommon | DownlinkConfigCommon | OPTIONAL, -- |

Cond HOAndServCellAdd

| | | |
|---|---|---|
| uplinkConfigCommon | UplinkConfigCommon | OPTIONAL, -- |

Need M

| | | |
|---|---|---|
| supplementaryUplinkConfig | UplinkConfigCommon | OPTIONAL, |

-- Need S

| | |
|---|---|
| n-TimingAdvanceOffset | ENUMERATED { n0, n25600, n39936 } |

OPTIONAL, -- Need S

| | |
|---|---|
| ssb-PositionsInBurst | CHOICE { |
| shortBitmap | BIT STRING (SIZE(4)), |
| mediumBitmap | BIT STRING (SIZE (8)), |
| longBitmap | BIT STRING (SIZE (64)) |
| } | OPTIONAL, -- Cond AbsFreqSSB |
| ssb-periodicityServingCell | ENUMERATED { ms5, ms10, ms20, ms40, ms80, |
| ms160, spare2, spare1 } | OPTIONAL, -- Need S |

...

A cell defining SSB (cell defining SSB, CD-SSB) and a non-cell defining SSB (non-cell defining SSB, NCD-SSB) are two different types of SSBs. The SSB includes a master information block (master information block, MIB). A part of information in the MIB may indicate whether the SSB is a cell defining SSB. The CD-SSB is mainly used for broadcasting and synchronization of a specific cell. Therefore, a part of information in the MIB indicates information related to a system information block (system information block-, SIB) 1. The terminal device may detect the SIB 1 based on the information related to the SIB 1, and then perform initial access. The NCD-SSB is mainly used for system information broadcasting and global radio resource management. A part of information in the MIB does not indicate information related to a SIB 1, but indicates information related to an SSB. Therefore, the terminal device cannot perform initial access by using the NCD-SSB.

As described above, in a communications system, the terminal device may perform initial access based on a target SSB (for example, a cell defining SSB). However, when the target SSB is an on-demand SSB, the terminal device that does not support the on-demand SSB performs initial access based on the target SSB, which may cause an access error.

For example, in a hybrid deployment scenario, a low version of terminal device does not support an on-demand SSB, and a high version of terminal device supports an on-demand SSB. If the terminal device has not received SSB modification signalling, the terminal device considers that the SSB constantly exists, and still performs periodic transmission. When transmission of an on-demand target SSB stops, the network device does not instruct, in a conventional manner (that is, periodic SSB transmission), to stop transmission of the target SSB. Instead, the network device instructs, in a new manner (that is, on-demand SSB transmission), to stop transmission of the target SSB. The low version of terminal device can not receive a new manner notification message, and considers that the target SSB is still periodically transmitted. In this case, the low version of terminal device may receive a target SSB requested by the high version of terminal device on demand, and the target SSB may be a cell defining SSB. The low version of terminal device performs access based on the target SSB. This may cause an access error.

To resolve the foregoing problem, an embodiment of the present application provides a wireless communication method. A network device transmits first information to a terminal device, to indicate that a target SSB transmitted on demand is not used by the terminal device to access a first cell associated with the target SSB. An access error of the terminal device that does not support an on-demand SSB may be reduced based on the first information, to improve communication efficiency.

With reference to FIG. 2, the following describes a wireless communication method according to an embodiment of the present application. FIG. 2 is a schematic flowchart of a wireless communication method according to an embodiment of the present application. The method shown in FIG. 2 includes step S210.

Step S210: A network device transmits first information to a terminal device.

In some implementations, the first information is used to indicate that a target SSB is not used by the terminal device to access a first cell associated with the target SSB, and transmission of the target SSB is triggered based on a request of the terminal device. In other words, it may be determined, based on the first information, that the target SSB transmitted on demand is not used by the terminal device to access the first cell.

In this embodiment of the present application, the first cell is not limited. For example, the first cell may be an SCell. For another example, the first cell may be a PCell.

In some implementations, that the first cell is associated with the target SSB may be understood as that the target SSB is transmitted in the first cell. For example, the first cell is the SCell, and that the target SSB is transmitted in the SCell is configured by using ServingCellConfigCommon.

In another implementation, that the first cell is associated with the target SSB may be understood as that the target SSB carries or indicates information of the first cell.

In some implementations, the target SSB is a cell defining SSB. In other words, initial access may be performed based on the target SSB.

In some other implementations, the target SSB is a non-cell defining SSB. In other words, initial access may be not performed based on the target SSB.

In some implementations, the first information is used to indicate that the target SSB is not used by the terminal device to access the first cell associated with the target SSB. It may be understood that the first information is used to indicate that the target SSB is the non-cell defining SSB.

In some implementations, if the target SSB is the cell defining SSB, the first information is used to indicate that the target SSB is the non-cell defining SSB, that is, the first information is used to indicate that the cell defining SSB is the non-cell defining SSB.

In some implementations, if the target SSB is the non-cell defining SSB, the first information is used to indicate that the target SSB is the non-cell defining SSB, that is, the first information is used to indicate that the non-cell defining SSB is the non-cell defining SSB.

In some implementations, the first information is carried in a MIB of the target SSB. For example, if the first information is carried in a field in the MIB, and a value of the field is a first value, it indicates that the target SSB is the non-cell defining SSB. For another example, the first value may be 0 or 1. The first information is carried in the MIB, which facilitates reducing transmission overheads of the first information.

In some other implementations, the first information is carried in a first signal, and the first signal is transmitted before the target SSB, which facilitates increasing transmission flexibility of the first information.

In some implementations, if the target SSB is the cell defining SSB, one or more fields in the MIB are used to carry information associated with the target SSB.

In some other implementations, if the target SSB is the non-cell defining SSB, one or more fields in the MIB are used to carry information associated with the target SSB.

In some implementations, one or more fields in the MIB may be referred to as a “field A”, and the field A carries the information associated with the target SSB, which facilitates obtaining accurate information by a terminal device that does not support an on-demand SSB.

In some implementations, the information that is associated with the target SSB and that is carried in the field A may be understood as content of a field A of a conventional non-cell defining SSB.

In some implementations, the network device transmits second information to the terminal device. The second information is used to indicate whether the first cell supports triggering SSB transmission based on the request of the terminal device, that is, the second information is used to indicate whether the first cell supports the on-demand SSB. Correspondingly, by receiving the second information, the terminal device may determine whether the first cell supports transmission of the on-demand SSB.

In some implementations, the second information is carried in a field. For example, if a value of the field is the first value, it indicates that the first cell supports the on-demand SSB. If a value of the field is a second value, it indicates that the first cell does not support the on-demand SSB. The first value is different from the second value. For example, the first value may be 0, and the second value may be 1. For another example, the first value may be 1, and the second value may be 0.

In some implementations, the terminal device receives, in the first cell, the target SSB transmitted by the network device; and detects a SIB 1 associated with the target SSB, to determine whether the target SSB is the cell defining SSB or the non-cell defining SSB.

In some implementations, if the terminal device detects the SIB 1 associated with the target SSB, the target SSB is the cell defining SSB. For example, when the terminal device detects the SIB 1 associated with the target SSB (for example, completes a cyclic redundancy check (cyclic redundancy check, CRC) for the SIB 1), the terminal device may determine that the target SSB is the cell defining SSB.

In some implementations, if the terminal device does not detect the SIB 1 associated with the target SSB, the target SSB is the non-cell defining SSB.

In some implementations, if both the first cell and the terminal device support triggering SSB transmission based on the request of the terminal device, the terminal device detects the SIB 1 associated with the target SSB, that is, if the target SSB is the on-demand SSB, a terminal device that supports an on-demand SSB detects the SIB 1 associated with the target SSB.

In some implementations, if the target SSB is the cell defining SSB, the information associated with the target SSB is carried in configuration information of the first cell.

In some implementations, the configuration information of the first cell includes downlinkConfigCommon. For example, it is assumed that the first cell is the SCell, the terminal device may be notified of the information associated with the SSB in downlinkConfigCommon signalling configured in the SCell.

In some implementations, the information associated with the target SSB includes a time resource and/or a frequency resource used to detect the SIB 1 associated with the target SSB. For example, the information associated with the target SSB includes Kssb and pdcch-ConfigSIB1. Based on Kssb and pdcch-ConfigSIB1, information about a common control information resource set (control-resource set, CORESET) may be determined. The terminal device may blindly detect the SIB 1 associated with the target SSB in the common CORESET. It should be noted that Kssb and pdcch-ConfigSIB1 are content in a MIB of a conventional cell defining SSB. For another example, the information associated with the target SSB includes the time resource and/or the frequency resource for transmitting the SIB 1 associated with the target SSB. The time resource may include a symbol, a slot, a subframe, a frame, and the like. The frequency resource may include a subcarrier, a frequency band, a bandwidth, and the like. The SIB 1 associated with the target SSB may be detected on the time resource and/or the frequency resource for transmitting the SIB 1 associated with the target SSB.

When the target SSB is the non-cell defining SSB, decoding processing performed by the terminal device on the SIB 1 is added in the foregoing method for detecting the SIB 1 associated with the target SSB to determine whether the target SSB is the cell defining SSB increases. To avoid unnecessary decoding, in some implementations, the network device transmits third information to the terminal device, where the third information is used to indicate whether an SSB transmitted in the first cell is a non-cell defining SSB or a cell defining SSB, and the SSB transmitted in the first cell includes the target SSB.

In some implementations, the third information is carried in the configuration information of the first cell. For example, the configuration information of the first cell includes a first field. When a value of the first field is a first value, it indicates that the SSB transmitted in the first cell is the cell defining SSB. When a value of the first field is a second value, it indicates that the SSB transmitted in the first cell is the non-cell defining SSB. The first value is different from the second value. For example, the first value may be 0, and the second value may be 1. For another example, the first value may be 1, and the second value may be 0.

In some implementations, the third information is carried in an SMTC window of the first cell. For example, the first cell is the SCell, and the third information is carried in an SMTC in SCellConfig below.

| SCellConfig ::= | SEQUENCE { | |
|---|---|---|
| sCellIndex | SCellIndex, | |
| sCellConfigCommon | ServingCellConfigCommon | OPTIONAL, -- |

Cond SCellAdd

| | | |
|---|---|---|
| sCellConfigDedicated | ServingCellConfig | OPTIONAL, -- |

```
Cond SCellAddMod
    ...,
    [[
```

| | | |
|---|---|---|
| smtc | SSB-MTC | OPTIONAL -- |

```
Need S
  ]],
  ...
```

In some other implementations, the third information is carried in higher layer signalling of the first cell. For example, the first cell is the SCell, and the third information is carried in SCellConfigCommon in the foregoing secondary cell configuration information SCellConfig.

It should be noted that when the third information is used to indicate whether the SSB transmitted in the first cell is the cell defining SSB or the non-cell defining SSB, the information associated with the target SSB in the solution using the second information may also be used to detect the SIB 1 associated with the target SSB. For details of explanation of the information associated with the target SSB, reference may be made to the foregoing description. Details are not described herein again.

It may be learned from the foregoing that the network device may be configured to transmit the SSB in the SCell. However, how to activate transmission of an on-demand SSB after the SCell is configured for the terminal device is a problem to be urgently resolved.

To resolve the foregoing problem, an embodiment of the present application proposes a wireless communication method. When a status of the secondary cell is to change or has changed (for example, the secondary cell is activated or the network device instructs to activate the secondary cell), the network device transmits fourth information to the terminal device, to instruct to activate the on-demand SSB.

With reference to FIG. 3, the following describes a wireless communication method according to an embodiment of the present application. FIG. 3 is a schematic flowchart of a wireless communication method according to an embodiment of the present application. The method shown in FIG. 3 includes step S310.

In step S310, in response to a first event, a network device transmits fourth information to a terminal device.

In some implementations, the fourth information is used to instruct to activate a target SSB in a secondary cell, and transmission of the target SSB is triggered based on a request of the terminal device, that is, the fourth information is used to instruct to activate an on-demand SSB in the secondary cell. Correspondingly, the terminal device receives the fourth information, and may transmit a request to request the network device to transmit an on-demand SSB.

In some implementations, the first event includes one or more of the following: that the secondary cell is configured; that the secondary cell is activated; or that the network device instructs to activate the secondary cell. For example, with reference to FIG. 4, the secondary cell is configured at an instant T1, the network device instructs to activate the secondary cell at an instant T2, the secondary cell is activated at an instant T3, and the network device may transmit the fourth information to the terminal device at an instant between T1 and T2, at an instant between T2 and T3, and after the instant T3. In other words, after the SCell is configured, the on-demand SSB may be activated at different stages.

In some implementations, that the network device instructs to activate the secondary cell may be understood as that the terminal device receives a command that is transmitted by the network device to activate the secondary cell.

In some implementations, the fourth information is carried in a serving cell common configuration associated with the secondary cell. For example, the fourth information is carried in ServingCellConfigCommon above. For another example, the fourth information is carried in a field in ServingCellConfigCommon. When a value of the field is a first value, it indicates that the on-demand SSB is activated in the secondary cell. For another example, the first value may be 0 or 1.

The method embodiments of the present application are described in detail above with reference to FIG. 1 to FIG. 4. Apparatus embodiments of the present application are described in detail below with reference to FIG. 5 to FIG. 9. It should be understood that the description of the method embodiments corresponds to the description of the apparatus embodiments, and therefore, for a part that is not described in detail, reference may be made to the foregoing method embodiments.

FIG. 5 is a schematic diagram of a terminal device according to an embodiment of the present application. The terminal device 500 includes a receiving unit 510.

The receiving unit 510 is configured to receive first information that is associated with a target SSB and that is transmitted by a network device, where the first information is used to indicate that the target SSB is not used by the terminal device to access a first cell associated with the target SSB, where the target SSB is a non-cell defining SSB or a cell defining SSB, and transmission of the target SSB is triggered based on a request of the terminal device.

In some implementations, the first information is used to indicate that the target SSB is the non-cell defining SSB.

In some implementations, the first information is carried in a MIB of the target SSB.

In some implementations, if the target SSB is the cell defining SSB, one or more fields in the MIB are used to carry information associated with the target SSB.

In some implementations, the terminal device further includes: the receiving unit, further receiving second information transmitted by the network device, where the second information is used to indicate whether the first cell supports triggering SSB transmission based on the request of the terminal device.

In some implementations, the terminal device further includes: the receiving unit, further receiving, in the first cell, the target SSB transmitted by the network device; and a detection unit, detecting a SIB 1 associated with the target SSB, to determine whether the target SSB is the cell defining SSB or the non-cell defining SSB.

In some implementations, that the terminal device detects the SIB 1 associated with the target SSB includes: that if both the first cell and the terminal device support triggering SSB transmission based on the request of the terminal device, the terminal device detects the SIB 1 associated with the target SSB.

In some implementations, the terminal device further includes: the receiving unit, further receiving third information transmitted by the network device, where the third information is used to indicate whether an SSB transmitted in the first cell is a cell defining SSB or a non-cell defining SSB, and the SSB transmitted in the first cell includes the target SSB.

In some implementations, the third information is carried in one or more of the following: configuration information of the first cell; an SMTC of the first cell; or SCellConfigCommon of the first cell.

In some implementations, if the target SSB is the cell defining SSB, the information associated with the target SSB is carried in configuration information of the first cell.

In some implementations, the configuration information of the first cell includes downlinkConfigCommon.

In some implementations, the information associated with the target SSB includes a time resource and/or a frequency resource used to detect the SIB 1 associated with the SSB.

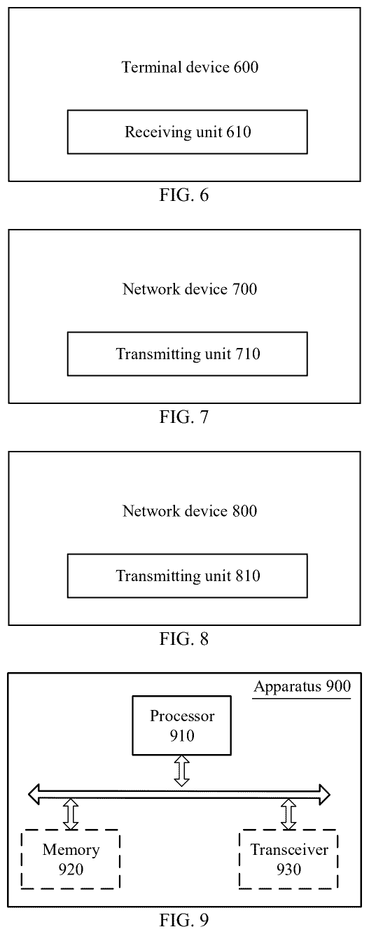

FIG. 6 is a schematic diagram of a terminal device according to an embodiment of the present application. The terminal device 600 includes a receiving unit 610.

In some implementations, the receiving unit 610 is configured to: in response to a first event, receive fourth information transmitted by a network device, where the fourth information is used to instruct to activate a target SSB in a secondary cell, and transmission of the target SSB is triggered based on a request of the terminal device, where the first event includes one or more of the following: that the secondary cell is configured; that the secondary cell is activated; or that the network device instructs to activate the secondary cell.

In some implementations, the fourth information is carried in a serving cell common configuration associated with the secondary cell.

FIG. 7 is a schematic diagram of a network device according to an embodiment of the present application. The network device 700 includes a transmitting unit 710.

The transmitting unit 710 is configured to transmit first information associated with a target SSB to a terminal device, where the first information is used to indicate that the target SSB is not used by the terminal device to access a first cell associated with the target SSB, where the target SSB is a non-cell defining SSB or a cell defining SSB, and transmission of the target SSB is triggered based on a request of the terminal device.

In some implementations, the first information is used to indicate that the target SSB is the non-cell defining SSB.

In some implementations, the first information is carried in a MIB of the target SSB.

In some implementations, if the target SSB is the cell defining SSB, one or more fields in the MIB are used to carry information associated with the target SSB.

In some implementations, the network device further includes: the transmitting unit, further transmitting second information to the terminal device, where the second information is used to indicate whether the first cell supports triggering SSB transmission based on the request of the terminal device.

In some implementations, the network device further includes: the transmitting unit, further transmitting third information to the terminal device, where the third information is used to indicate whether an SSB transmitted in the first cell is a cell defining SSB or a non-cell defining SSB, and the SSB transmitted in the first cell includes the target SSB.

In some implementations, the third information is carried in one or more of the following: configuration information of the first cell; an SMTC of the first cell; or SCellConfigCommon of the first cell.

In some implementations, if the target SSB is the cell defining SSB, the information associated with the target SSB is carried in configuration information of the first cell.

In some implementations, the configuration information of the first cell includes downlinkConfigCommon.

In some implementations, the information associated with the target SSB includes a time resource and/or a frequency resource used to detect the SIB 1 associated with the SSB.

FIG. 8 is a schematic diagram of a network device according to an embodiment of the present application. The network device 800 includes a transmitting unit 810.

The transmitting unit 810 is configured to: in response to a first event, transmit fourth information to a terminal device, where the fourth information is used to instruct to activate a target SSB in a secondary cell, and transmission of the target SSB is triggered based on a request of the terminal device, where the first event includes one or more of the following: that the secondary cell is configured; that the secondary cell is activated; or that the network device instructs to activate the secondary cell.

In some implementations, the fourth information is carried in a serving cell common configuration associated with the secondary cell.

In an optional embodiment, the receiving unit 510 may be a transceiver 930. The terminal device 500 may further include a processor 910 and a memory 920, which are specifically shown in FIG. 9.

In an optional embodiment, the receiving unit 610 may be a transceiver 930. The terminal device 600 may further include a processor 910 and a memory 920, which are specifically shown in FIG. 9.

In an optional embodiment, the transmitting unit 710 may be a transceiver 930. The network device 700 may further include a processor 910 and a memory 920, which are specifically shown in FIG. 9.

In an optional embodiment, the transmitting unit 810 may be a transceiver 930. The network device 800 may further include a processor 910 and a memory 920, which are specifically shown in FIG. 9.

FIG. 9 is a schematic diagram of a structure of a communications apparatus according to an embodiment of the present application. Dashed lines in FIG. 9 indicate that a unit or module is optional. The apparatus 900 may be configured to implement the method described in the foregoing method embodiment. The apparatus 900 may be a chip, a terminal device, or a network device.

The apparatus 900 may include one or more processors 910. The processor 910 may support the apparatus 900 in implementing the method described in the foregoing method embodiment. The processor 910 may be a general-purpose processor or a dedicated processor. For example, the processor may be a central processing unit (central processing unit, CPU). Alternatively, the processor may be another general-purpose processor, a digital signal processor (digital signal processor, DSP), an application specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 900 may further include one or more memories 920. The memory 920 stores a program, and the program may be executed by the processor 910, so that the processor 910 executes the method described in the foregoing method embodiment. The memory 920 may be separate from or integrated into the processor 910.

The apparatus 900 may further include a transceiver 930. The processor 910 may communicate with another device or chip through the transceiver 930. For example, the processor 910 may transmit data to and receive data from another device or chip through the transceiver 930.

An embodiment of the present application further provides a computer-readable storage medium for storing a program. The computer-readable storage medium may be applied to the terminal or the network device provided in embodiments of the present application, and the program causes a computer to execute the method performed by the terminal or the network device in various embodiments of the present application.

An embodiment of the present application further provides a computer program product. The computer program product includes a program. The computer program product may be applied to the terminal or the network device provided in embodiments of the present application, and the program causes a computer to execute the methods performed by the terminal or the network device in various embodiments of the present application.

An embodiment of the present application further provides a computer program. The computer program may be applied to a terminal or a network device provided in embodiments of the present application, and the computer program causes a computer to execute the methods performed by the terminal or the network device in various embodiments of the present application.

It should be understood that the terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular order. In addition, the terms “include” and “have” and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In several embodiments provided in the present application, it should be understood that, the disclosed system, apparatus, and method may be implemented in other manners. For example, the described apparatus embodiments are merely examples. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may be or may not be physically separate, and parts displayed as units may be or may not be physical units, and may be at one location, or may be distributed on a plurality of network elements. A part or all of the units may be selected based on actual requirements to achieve the objectives of the solutions of embodiments.

In addition, functional units in embodiments of the present application may be integrated into one processing unit, or each of the units may exist alone physically, or two or more units may be integrated into one unit.

All or a part of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drive, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A wireless communication method, comprising:
receiving, by a terminal device from a network device, first information that is associated with a target synchronization signal block (SSB), wherein the first information indicates that the target SSB is not used by the terminal device to access a first cell associated with the target SSB, wherein the target SSB is a non-cell defining SSB or a cell defining SSB; and
transmitting, by the terminal device, a request for the target SSB.

2. The method according to claim 1, wherein the first information indicates that the target SSB is the non-cell defining SSB.

3. The method according to claim 1, wherein the first information is carried in a master information block (MIB) of the target SSB.

4. The method according to claim 3, wherein the target SSB is the cell defining SSB, and one or more fields in the MIB carry information associated with the target SSB.

5. The method according to claim 1, wherein the method comprises:
receiving, by the terminal device, second information from the network device, wherein the second information indicates whether the first cell supports triggering SSB transmission based on the request of the terminal device.

6. The method according to claim 1, wherein the method comprises:
receiving, in the first cell by the terminal device, the target SSB from the network device; and
detecting, by the terminal device, a system information block (SIB) 1 associated with the target SSB, to determine whether the target SSB is the cell defining SSB or the non-cell defining SSB.

7. The method according to claim 6, wherein the detecting, by the terminal device, a SIB 1 associated with the target SSB comprises:
when both the first cell and the terminal device support triggering SSB transmission based on the request of the terminal device, detecting, by the terminal device, the SIB 1 associated with the target SSB.

8. The method according to claim 1, wherein the method comprises:
receiving, by the terminal device, third information from the network device, wherein the third information indicates whether an SSB transmitted in the first cell is a cell defining SSB or a non-cell defining SSB, and the SSB transmitted in the first cell comprises the target SSB.

9. The method according to claim 8, wherein the third information is carried in one or more of following:
configuration information of the first cell;
an SSB measurement timing configuration (SMTC) of the first cell; or
SCellConfigCommon of the first cell.

10. The method according to claim 1, wherein the target SSB is the cell defining SSB, and information associated with the target SSB is carried in configuration information of the first cell.

11. The method according to claim 10, wherein the configuration information of the first cell comprises downlinkConfigCommon.

12. The method according to claim 10, wherein the information associated with the target SSB comprises at least one of a time resource or a frequency resource used to detect a SIB 1 associated with the target SSB.

13. A wireless communication method, comprising:
in response to a first event, receiving, by a terminal device, fourth information from a network device, wherein the fourth information is used to instruct to activate a target SSB in a secondary cell, and transmission of the target SSB is triggered based on a request of the terminal device, wherein
the first event comprises one or more of following:
that the secondary cell is configured;
that the secondary cell is activated; or
that the network device instructs to activate the secondary cell.

14. The method according to claim 13, wherein the fourth information is carried in a serving cell common configuration associated with the secondary cell.

15. A wireless communication method, comprising:
transmitting, by a network device, first information associated with a target SSB to a terminal device, wherein the first information indicates that the target SSB is not used by the terminal device to access a first cell associated with the target SSB, wherein
the target SSB is a non-cell defining SSB or a cell defining SSB, and transmission of the target SSB is triggered based on a request of the terminal device.

16. The method according to claim 15, wherein the first information indicates that the target SSB is the non-cell defining SSB.

17. The method according to claim 15, wherein the first information is carried in a MIB of the target SSB.

18. The method according to claim 17, wherein the target SSB is the cell defining SSB, and one or more fields in the MIB are used to carry information associated with the target SSB.

19. The method according to claim 15, wherein the method comprises:
transmitting, by the network device, second information to the terminal device, wherein the second information indicates whether the first cell supports triggering SSB transmission based on the request of the terminal device.

20. The method according to claim 15, wherein the method comprises:
transmitting, by the network device, third information to the terminal device, wherein the third information indicates whether an SSB transmitted in the first cell is a cell defining SSB or a non-cell defining SSB, and the SSB transmitted in the first cell comprises the target SSB.
